(19) United States
(12) Patent Application Publication
(10) Pub. No.: US 2018/0301785 A1
(43) Pub. Date: Oct. 18, 2018

(54) A COMMUNICATION MEANS AND THE HOUSEHOLD APPLIANCE WHEREIN THE SAME IS USED

(71) Applicant: ARCELIK ANONIM SIRKETI, Istanbul (TR)

(72) Inventors: Sezgi YIKILMAZCINAR, Istanbul (TR); Ibrahim Niyazi ULGUR, Istanbul (TR); Hakan OZKAHRAMAN, Istanbul (TR); Selami SEVIK, Istanbul (TR)

(21) Appl. No.: 15/765,191

(22) PCT Filed: Aug. 8, 2016
(86) PCT No.: PCT/TR2016/050275

§ 371 Date: Mar. 30, 2018

(30) Foreign Application Priority Data
Oct. 8, 2015 (TR) 2015/12520

(51) Int. Cl. H01Q 1/22; H01Q 1/48

(52) U.S. Cl. CPC H01Q 1/22; H01Q 1/48

(57) ABSTRACT

The present invention relates to a communication means that provides the household appliance wherein the communication means is used with wireless transmission feature and that comprises a feeding unit, a printed circuit board, and an antenna that is disposed on the printed circuit board and that has a ground section, a feed point, a linear section that extends from the feed point in a certain length and more than one branch that is disposed on the linear section and perpendicular to the linear section.

The present invention relates to a communication means that provides communication between the household appliances and between the household appliances and the user, and relates to a household appliance wherein the said communication means is used.

Household appliances can be controlled with the buttons provided thereon or by means of remote control methods. Moreover, in addition to the normal functions the household appliances have various functions such as connecting to the Internet, media playing, etc. Antennas used in wireless communication for these purposes are of utmost importance. According the radio frequency arrangements, antenna frequencies that can be used for wireless communication without obtaining licenses are determined. Frequencies that the household appliances can use are defined as ISM (Industrial, scientific and medical) band. In the technique, the communication means are used externally or as integrated in the household appliances. In the integrated communication means, the use of a low-cost communication means that is composed of an antenna printed on a printed circuit board is known. As the household appliance should communicate with the user and the other household appliances, the designed antenna is required to broadcast in all directions. The antenna designed to be printed onto the printed circuit board is required to be tolerant against the mass production errors and to fit onto the printed circuit board and to occupy little space. Moreover, problems of inefficiency resulting from the small size of the antenna should be solved.

In the state of the art European Patent Application No. EP1483803, a microwave antenna with more than one feed points is disclosed.

In the state of the art European Patent Application No. EP2763238, a printed circuit board antenna that can work in different frequencies is disclosed.

In the state of the art European Patent Application No. EP1095422, a printed antenna that can work in different frequencies is disclosed.

The aim of the present invention is the realization of a small-sized and low-cost communication means and a household appliance wherein the said communication means is used.

The communication means realized in order to attain the aim of the present invention, explicated in the first claim and the respective claims thereof, comprises an antenna that is printed on the printed circuit board and that has at least one branch on the linear section, that is perpendicular to the linear section, with variable widths perpendicular to the linear section and a ground section that moves away from the linear section so as to open sideways.

In the household appliance, for example, the user sends a command to the household appliance by means of a terminal such as cell phone, etc. and the antenna receives the signal containing the command and delivers the same to the control unit. The control unit decodes the signal and provides the realization of the command.

There are five branches on the linear section so as to be perpendicular to the linear section and the branches have almost the same lengths. Moreover, the branches are connected to the linear section so as to be offset from their centers and the distances between each two successive branches are almost equal for the four branches close to the feed point. The lengths of the branches are preferably almost one tenth of the resonance wavelength.

Moreover, the cross-sections of the branches in the direction parallel to the linear section are variable. The cross-sections of the braches narrow as moved away from the linear section. The cross-sections of the branches abruptly change, in other words the change in the cross-sections resembles to step function.

Starting from the feeding unit, the ground section moves parallel to the linear section and then opens sideways so as to make an angle half of the right angle. Two sides of the ground section is not symmetrical and the length of one side perpendicular to the linear section is almost twice the length of the other side perpendicular to the linear section and the length of the short side is one thirtieth of the resonance wavelength. The widths thereof are almost equal to each other and one hundredth of the resonance wavelength.

The said communication means has a simpler design than the state of the art means and is produced with lower costs. Moreover, the above-mentioned antenna pattern is resistant to production tolerances and is minimally affected by production errors. Thus, losses that may occur during mass production can be minimized, thus providing cost advantage.

By means of the above-mentioned antenna pattern, a small-sized communication means is realized in the license-free frequency band reserved for industrial use in radio frequency arrangements, in particular in a frequency of 2.4 GHz and the communication means can be easily integrated to the edge of the printed circuit board that constitutes the control card of the household appliance wherein the communication means is used.

In case the household appliance wherein the communication means of the present invention is used is a cooking device, the user can connect to the household appliance by his/her cell phone by means of the communication means and the control unit of the household appliance, and can control the household appliance. By means of the present invention, without using a screen or an interface on the household appliances, the user can connect the household appliance by means of his/her cell phone, preferably with Bluetooth and control the household appliance.

The household appliance wherein the communication means of the present invention is used is not limited to the above-mentioned sample household appliances, and can be a cooling device, a laundry washer and/or dryer, a dishwasher or a small home appliance.

The communication means realized in order to attain the aim of the present invention is illustrated in the attached figures, where:

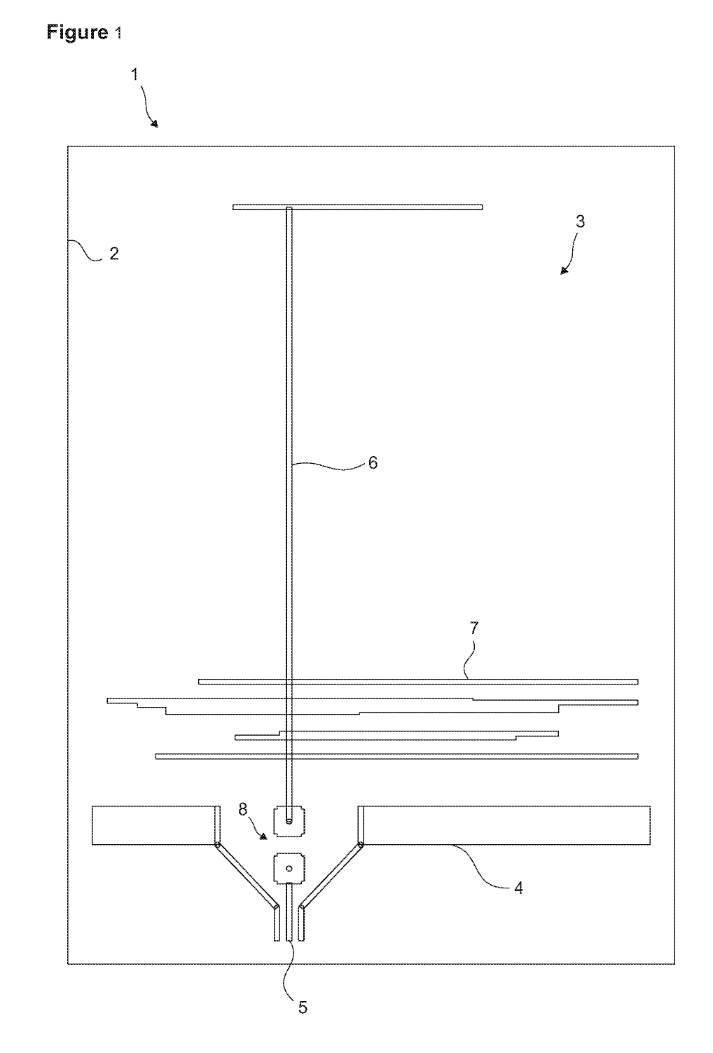

FIG. 1—is the schematic view of a communication means.

The elements in the figures are numbered as follows:
1. Communication means
2. Printed circuit board
3. Antenna
4. Ground section
5. Feed point
6. Linear section
7. Branch
8. Capacitor

The communication means (1) comprises a feeding unit (not shown in the figures), a printed circuit board (2), and an antenna (3) that is disposed on the printed circuit board (2) and that has a ground section (4), a feed point (5), a linear section (6) that extends from the feed point (5) in a certain length and more than one branch (7) that is disposed on the linear section (6) and perpendicular to the linear section (6).

The antenna (3) of the present invention comprises
at least two branches (7) with variable thicknesses, and
the ground section (4) with the starting point near the feed point (5), of which a portion after the starting point extends parallel to the linear section (6) and that opens sideways after the parallel portion.

The communication means (1) is driven in the resonance frequency over the feed point (5) by the feeding unit. Moreover, the feeding unit receives signals in the resonance frequency that is captured by the antenna (3). In other words, the communication means (1) works as a receiver and/or transmitter. The person skilled in the art can easily change the gain, efficiency, resonance frequency and bandwidth of the communication means (1) by changing the lengths of the branches (7) and the positions thereof on the linear section (6). The communication means (1) is explained hereinafter in detail.

The starting point of the ground section (4) of the antenna (3) is located near the feed point (5), and a portion of the ground section (4) after the starting point, that is one fiftieth of the resonance wavelength, extends parallel to the linear section (6) and opens sideways after the parallel portion. The ground section (4) opens sideways preferably in an angle close to 45°. The ground section (4) opening sideways gets wider so that the length thereof in the same direction as the linear section (6) has a width of approximately one hundredth of the resonance wavelength and the length thereof in the direction perpendicular to the linear section (6) is one thirtieth of the resonance wavelength at one side and one twelfth of the resonance wavelength at the other side respectively configured as two asymmetrical plates. By designing the ground section (4) in this manner, the outlets of the feeding unit can be used effectively.

The antenna (3) of the communication means (1) comprises five branches (7) that are perpendicularly positioned on the linear section (6) and the cross-sections of two branches (7) decrease as moved away from the linear section (6) like a step function while the remaining three has fixed cross-sections. The branches (7) with variable cross-sections are the second and third branches (7) closest to the feed point (5). Of the branches (7) with variable cross-sections, the closest to the feed point (5) has a single-step, in other words two different cross-sections and the farthest to the feed point (5) has a two-step, in other words three different cross-sections. The steps are present at both sides of the linear section (6) and the cross-sections can be symmetrical or asymmetrical.

The lengths of the branches are one seventh to one fifteenth of the resonance wavelength so as to be almost equal to each other. The branches (7) are connected to the linear section (6) so as to be offset from their center points, in other words, the branches (7) are asymmetrically arranged on the linear section (6). The four branches (7) closest to the feed point (5) are positioned on the linear section (6) at intervals so that the distances between the branches (7) are almost equal, preferably one two hundred fiftieth of the resonance wavelength. The branch (7) farthest to the feed point (5) is positioned at the end of the linear section (6) so as to form a T together with the linear section (6).

The antenna (3) furthermore comprises a capacitor (8) that is disposed between the feed point (5) and the branch (7) closest to the feed point (5) so as to be aligned with the ground section (4) on the linear section (6). The distance between the capacitor (8) and the closest branch (7) is preferably of a length that is one seventy fifth of the resonance wavelength. By means of the capacitor (8), in other words by means of the adjustable capacitance of the capacitor (8), the impedance value of the antenna (3) can be set as the desired impedance value.

A communication means (1) with the above-described antenna (3) pattern has a low gain, in other words is non-directional, and in other words omni-directionally sends signals in almost equal power. Thus, it is sufficient for the user to be around the household appliance in any direction, and he/she is not required to be directly at the front side of the household appliance.

The length of the linear section (6) of the antenna (3) is of a length that is one sixth of the resonance wavelength. Thus, a communication means (1) is realized, that is smaller than the communication means (1) with the state of the art monopole and dipole antennas (3).

The printed circuit board (2) has a thickness of 1.6 mm and is produced from FR4 material. As can be easily seen by the person skilled in the art, by using a printed circuit board (2) produced from a material with a different thickness and a dielectric coefficient in the antenna (3) pattern disclosed above, a communication means (1) with a different bandwidth can be produced.

In the above-described communication means (1), the lengths and distances given for the antenna (3) have a production tolerance of +−10%. The expressions such as “almost”, etc. in this description should be considered in light of this fact.

In the household appliance of the present invention, the above-described communication means (1) is used for wireless transmission. The household appliance can be an oven, a cooker, a dishwasher, an exhaust hood, a laundry washer or a refrigerator used in the user's kitchen or bathroom and requiring image and signal transmission to communicate with other household appliances and the user. For example, by means of the communication means (1) used in a refrigerator, the images of the refrigerator shelves are displayed for the user or the exhaust hood can capture the images of the foods that are being cooked on the cooker by means of the camera and the processor thereon so as to analyze the same and to send control commands to the cooker.

1. A communication means comprising a feeding unit, a printed circuit board, and an antenna that is disposed on the printed circuit board and that has a ground section, a feed point, a linear section that extends from the feed point in a certain length and more than one branch that is disposed on the linear section and perpendicular to the linear section, characterized by the antenna having
at least two branches with variable cross-sections, and
the ground section with the starting point near the feed point, of which a portion after the starting point extends parallel to the linear section and that opens sideways after the parallel portion.

2. A communication means as in claim 1, characterized by the ground section that opens sideways so as to make an angle of 45° with the linear section.

3. A communication means as in claim 1, characterized by the ground section of which the portion opening sideways is asymmetrical with respect to the linear section.

4. A communication means as in claim 3, characterized by the ground section that is in a length that is almost one thirtieth of the resonance wavelength at one side of the linear section and in a length that is almost one twelfth of the resonance wavelength at the other side.

5. A communication means as in claim 1, characterized by the branch that has a cross-section that gets narrower as moved away from the linear section.

6. A communication means as in claim 5, characterized by the branch of which the cross-section gets narrower in steps.

7. A communication means as in claim 5, characterized by two branches with stepped-cross-sections and three branches with fixed cross-sections, all disposed on the linear section.

8. A communication means as in claim 7, characterized by the branches with stepped-cross-sections, the closest to the feed point of which is one-stepped and the farthest two-stepped.

9. A communication means as in claim 1, characterized by the branches that are positioned on the linear section so as to be offset from their centers.

10. A communication means as in claim 1, characterized by a capacitor that is disposed between the feed point and the branch closest to the feed point so as to be aligned with the ground section on the linear section.

11. A communication means as in claim 10, characterized by the branches with a distance to the capacitor, that is in a length of one seventy fifth of the resonance wavelength.

12. A communication means as in claim 1, characterized by the branches whereof the lengths are between one seventh and one fifteenth of the resonance wavelength.

13. A communication means as in claim 1, characterized by the linear section in a length that is almost one sixth of the resonance wavelength.

14. A communication means as in claim 1, characterized by the branches the farthest to the feed point of which forms a T together with the linear section.

15. A household appliance wherein the communication means disclosed in claim 1 is u
